(19) United States
(12) Patent Application Publication
(10) Pub. No.: US 2013/0299295 A1
(43) Pub. Date: Nov. 14, 2013

(54) Hub and its Ratchet Wheel

(71) Applicant: KENLIGHT TRADING CORP., Taipei (TW)

(72) Inventor: Chia-Ling Yang, Taipei (TW)

(73) Assignee: Kenlight Trading Corp., Taipei (TW)

(21) Appl. No.: 13/786,543

(22) Filed: Mar. 6, 2013

(30) Foreign Application Priority Data
May 8, 2012 (TW) 101116430

(51) Int. Cl. F16D 41/12

(52) U.S. Cl. CPC F16D 41/12
USPC 192/64

(57) ABSTRACT

A hub includes an arbor shaft, a ratchet wheel, an internally-toothed ring, a shell, a clutch member and a second spring. The ratchet wheel includes at least one chain wheel, a plurality of concavities, a plurality of pawls and a plurality of first springs. The chain wheel and the concavities are disposed on two opposite sides of the ratchet wheel respectively. Each pawl has a first end and a second end. Each spring has a first end and a second end. The internally-toothed ring surrounds the pawls and has an inner periphery formed with a plurality of inner teeth. The clutch member has an axial hole and a cam. The present invention is advantageous in the way that the pawls and the internally-toothed ring do not make “kada-kada” rattle noise nor drive the pedals during idle running of the hub.

### FIELD OF THE INVENTION

The present invention relates to a hub, and more specifically to a hub having a simplified structure and is advantageous in the way that the pawls and the internally-toothed ring of the hub do not make “kada-kada” rattle noise nor drive the pedals during idle running of the hub.

### BACKGROUND

The present invention relates to a bicycle, and more specifically to a bicycle for performing shows. Bicycle motocross sport began in the United States of America in the 1970s, and bicycles used for such purpose are called BMX bicycles, which have smaller size and thicker tires, and whose racing tracks are very similar to those of the motocross. Although the bicycle motocross sport was a phenomenon among young groups, most of them, influenced by the skateboarding culture in the mid-1980s, felt unexciting to just race in purpose-built tracks until Bob Haro invented a new type of BMX bicycles with extra pedals installed on front and real wheels. With these pedals, the cyclists were capable of performing new fancy moves. Since then, people began to ride BMX bicycles on level grounds and skateparks, performing more tricks than skateboarding, jumping higher and becoming more exciting. Such type of BMX bicycles were then known as BMX freestyle bicycles.

Please refer to FIG. 1, which shows a conventional BMX bicycle. The bicycle 10 includes a frame 11, a rear wheel 14, a front wheel 14′ and transmission system 15, in which the front wheel 14′ and the rear wheel 14 are installed on the front suspension fork 12 and rear suspension fork 13 of the frame 11 respectively. The transmission system 15 includes a pair of pedals 16, a first chain wheel 17, a chain 18 and a hub 100. The user can drive the first chain wheel 17 to rotate by alternatively treading the pedals 16, and then the first chain wheel 17 rotates the chain 18 and transmits power to drive the rear wheel 14 through the shell 120 of the hub 100 so as to drive the bicycle 10 forward. Furthermore, pedals 19 and 19′ are sleeved onto axes of the rear wheel 14 and the front wheel 14′ respectively for the user to perform fancy moves.

FIG. 2 shows a hub used for a BMX freestyle bicycle. The hub 100 is mainly composed of an arbor shaft 110, a shell 120, a ratchet wheel 130, an internally-toothed ring 140 and a plurality of bearings 150. The shell 120 and the ratchet wheel 130 are sleeved onto the arbor shaft 110, and both the shell 120 and the ratchet wheel 130 are in rotatable connection with the arbor shaft 110 with the help of the bearings 150. Please further refer simultaneously to FIGS. 2 and 3, in which FIG. 3 shows a side view of the ratchet wheel and the internally-toothed ring. The ratchet wheel 130 includes a second chain wheel 132, a plurality of pawls 134 and a spring 136. The pawls 134, for example, are intermittently dispersed about the ratchet wheel 130, received in pawl concavities 138 of the ratchet wheel 130, and placed in positions with the help of the springs 136. Moreover, please refer to FIG. 4, which shows a perspective view of the shell and the internally-toothed ring. The internally-toothed ring 140 is formed with first right coiling threads 142, and an inner surface of the shell 120 is formed with second right coiling threads 122 which are engageable with the first right coiling threads 122. By screwing the internally-toothed ring 140 clockwise, the internally-toothed ring 140 can be fastened in the shell 120.

As known in FIGS. 3 and 4, when the chain 18 (as shown in FIG. 1) pulls the second chain wheel 132 (as shown in FIG. 2) to rotate clockwise, the ratchet wheel 130 can be driven to rotate. At such instance, the pawls 134 engage with teeth 144 of the internally-toothed ring 140 to drive rotation of the internally-toothed ring 140. When the internally-toothed ring 140 rotates, the shell 120 can also be driven to rotate and thus move the bicycle 10 forward. When the chain 18 pulls the second chain wheel 132 to rotate counterclockwise, the pawls 134 of the ratchet wheel 130 slide against the teeth 144 of the internally-toothed ring 140 and do not drive the shell 120 to rotate, which is so called “idle running.” During the idle running, the pawls 134 and the teeth 144 will make “kada-kada” rattle noise while the pawls 134 slide against the teeth 144 of the internally-toothed ring 140.

There are some occasions when a user performs fancy moves that the bicycle 10 stands on the front wheel 14′ to make the rear wheel 14 be independently rotated idly. Please refer to FIG. 3, when the rear wheel 14 idly rotates forward, i.e. the internally-toothed ring 140 rotates in clockwise direction, the teeth 144 of the internally-toothed ring 140 can slide against the pawls 134. And when the rear wheel 14 idly rotates backward, i.e. the internally-toothed ring 140 rotates in counterclockwise direction, the teeth 144 of the internally-toothed ring 140 engage with the pawls 134 and drive the ratchet wheel 130 to rotate backward. The ratchet wheel 130 then drives the second wheel 132 and pulls the chain 18 to make the pedals 16 rotate. However, the rotation of the pedals 16 can interfere or hurt the user.

TW pub. No. 201113167 (hereinafter '167) discloses a free coaster hub that the pedals are not driven when the rear wheel idly rotates backward. The free coaster hub includes a chain wheel holder, a ratchet wheel, a damping element and a shell. The chain wheel holder has a ratchet wheel mount formed with a plurality of controlling concavities at its periphery. The ratchet wheel is sleeved onto the ratchet wheel mount and formed with receiving chambers corresponding to the controlling concavities, in which pawls are pivotally received in the receiving chambers while rolling elements are disposed in between the controlling concavities and the pawls. The ratchet wheel further has radially protrusive protrusions which engage with slots of the damping element. The shell defines a receiving space for receiving the ratchet wheel and the damping element therein. The shell has inner teeth disposed annularly and engageable with the pawls. By means of the aforementioned structure, the rolling elements can cooperate with the controlling concavities and radially move outward to push the pawls protrusive from the receiving chambers. The pivotal movement of the pawls is thus smoother, reducing the wear and increasing the durability thereof.

As disclosed in '167, the pawls received in the receiving chambers are controlled by the relative movement of the rolling elements and the damping element in the manner that the resilience of the damping element can control inward retraction of the pawls and thus the pawls maintain retracted in natural state. In other words, such design does not make rattle noise nor drive the pedals to rotate when the rear wheel idly rotates backward. The conventional art of '167, nevertheless, is complicate in structure and thus increases the developing cost of the hub and, as a result, increases the total cost of the bicycle.

### SUMMARY OF THE INVENTION

The primary objective of the present invention is to provide a hub, which has a simplified structure and whose pawls and internally-toothed ring do not make “kada-kada” rattle noise nor drive rotation of the pedals when the hub is idle running.

To achieve the above and other objectives, the present invention provides a hub adapted to be disposed on a bicycle. The hub includes an arbor shaft, a ratchet wheel, an internally-toothed ring, a shell, a clutch member and a second spring. The ratchet wheel is sleeved on the arbor shaft and includes at least one chain wheel, a plurality of concavities, a plurality of pawls and a plurality of first springs. The chain wheel is disposed on one side of the ratchet wheel, and the concavities are disposed on the other side thereof. Each concavity has a first sub-concavity, a second sub-concavity and a bottom surface. Each of the first sub-concavities and second sub-concavities defines a cylinder space, and the bottom surface of each concavity is connected between the first sub-concavity and the second sub-concavity of the same concavity. Moreover, each pawl has a first end and a second end. The first end of each pawl is disposed in one of the first sub-concavities. Each first spring has a first end and a second end. The first end of each first spring is disposed in one of the second sub-concavities, and the second end of each first spring applies a resilient force on one of the pawls.

The aforesaid internally-toothed ring surrounds the pawls and has an inner periphery formed with a plurality of teeth. Each tooth is adapted for the second end of one of the pawls to engage therewith. Furthermore, the shell is sleeved on the arbor shaft. The clutch member has an axial hole, and the clutch member is sleeved onto the arbor shaft with the axial hole. The clutch member has a cam. The cam has a plurality of protrusions. Each protrusion is corresponded to one of the pawls. The second spring is sleeved onto the arbor shaft, and the second spring has one of its ends applying a resilient force on the clutch member and presses the clutch member against the ratchet wheel.

When the ratchet wheel rotates in a first direction relative to the clutch member, each protrusion of the cam abuts against the respective pawl to make the second end of the respective pawl protrusive from the respective concavity. When the ratchet wheel rotates in a second direction relative to the clutch member, each protrusion of the cam is separated from the respective pawl such that the respective pawl is retracted into the respective concavity by the resilient force applied by the respective first spring, in which the first direction is opposite to the second direction.

In the aforesaid hub, the first sub-concavity and the second sub-concavity of each concavity are symmetric to each other.

In the aforesaid hub, each pawl includes a first claw plate, a second claw plate and a connecting surface. The connecting surface of each pawl is connected between the first claw plate and the second claw plate of the same pawl, and the second end of each first spring abuts against one of the connecting surfaces. When the ratchet wheel rotates in the second direction relative to the clutch member, each protrusion of the cam is separated from the respective pawl such that the respective pawl is retracted into the respective concavity and appressed to the bottom surface of the respective concavity by the resilient force applied by the respective first spring.

The aforesaid hub further includes a sleeve. The sleeve is made of metal, and the sleeve is mounted in the axial hole of the clutch member and sleeved onto the arbor shaft.

### BRIEF DESCRIPTION OF THE DRAWINGS

FIG. 1 is a diagram showing a conventional BMX bicycle;

FIG. 2 is a diagram showing a hub used for a BMX freestyle bicycle;

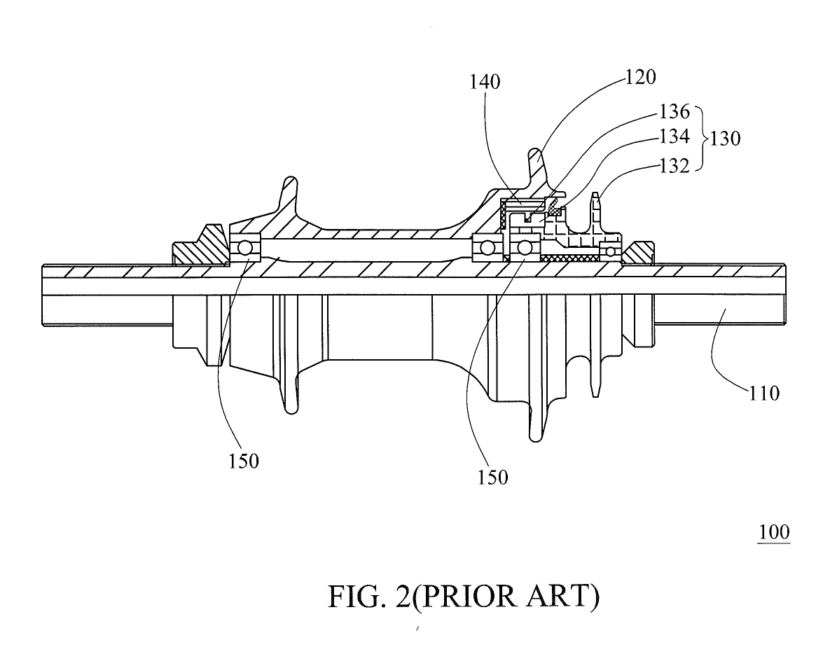

FIG. 3 is a diagram showing a side view of the ratchet wheel and the internally-toothed ring;

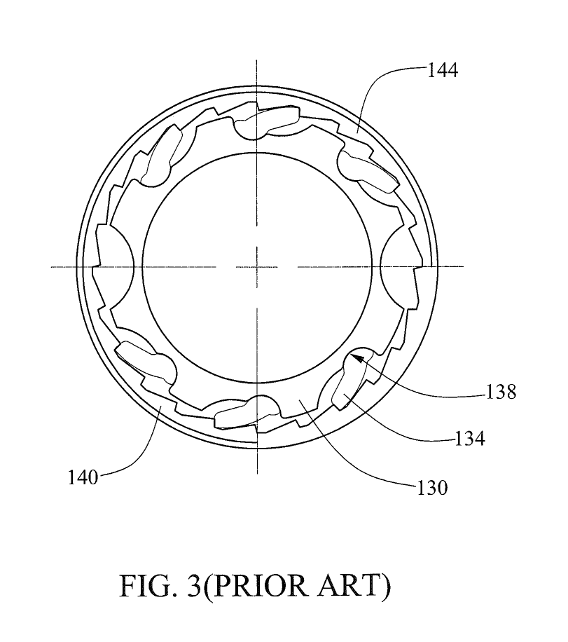

FIG. 4 is a diagram showing a perspective view of the shell and the internally-toothed ring;

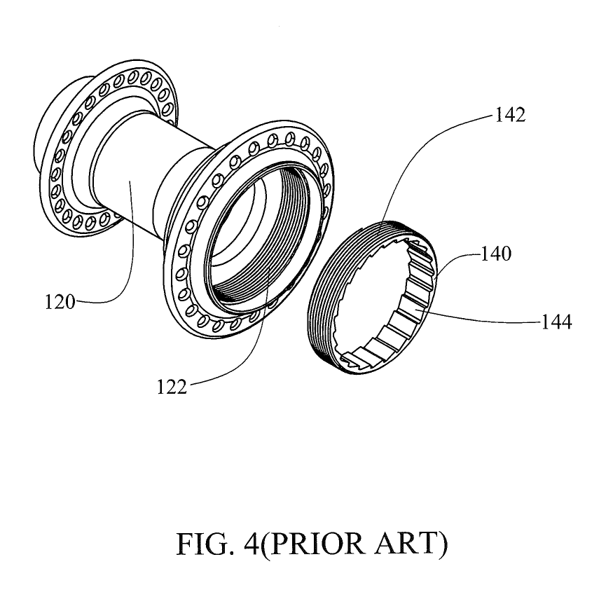

FIG. 5 is a diagram showing an explosive drawing of a hub of the present embodiment;

FIG. 6A is a diagram showing a schematic drawing of a ratchet wheel of the present embodiment;

FIG. 6B is a diagram showing a schematic drawing of a pawl of the present invention;

FIG. 7 is a diagram showing a schematic drawing of a clutch member of the present embodiment;

FIG. 8 is a diagram showing a relative movement of a ratchet wheel and a clutch member of the present embodiment;

FIG. 9 is a diagram showing a schematic drawing of a ratchet wheel of another embodiment.

### DETAILED DESCRIPTION

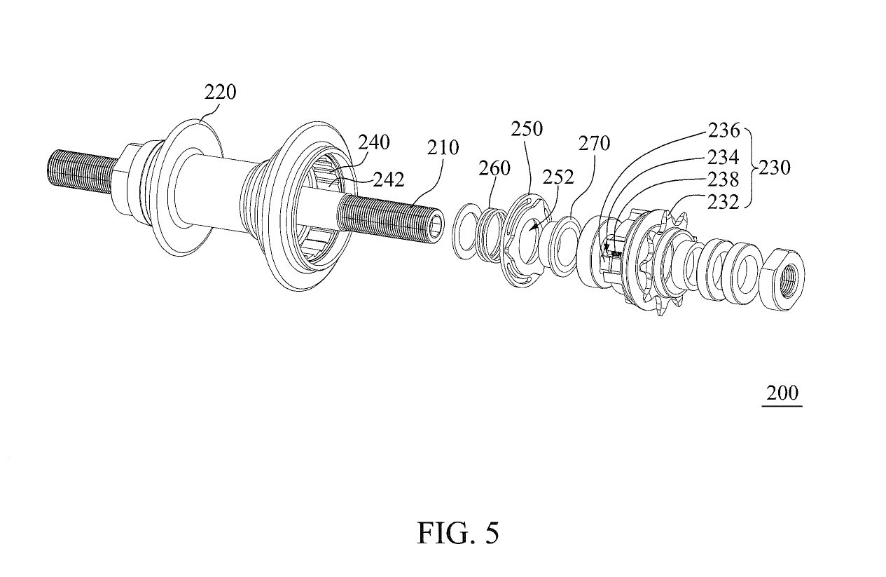

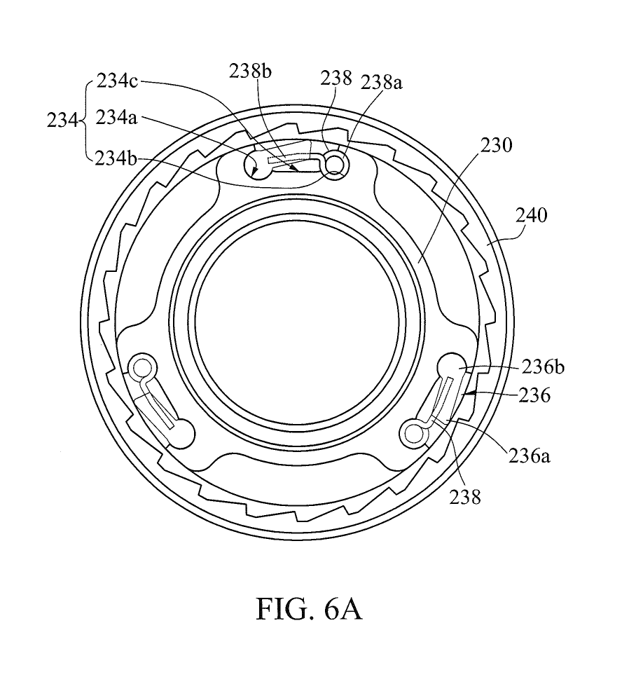

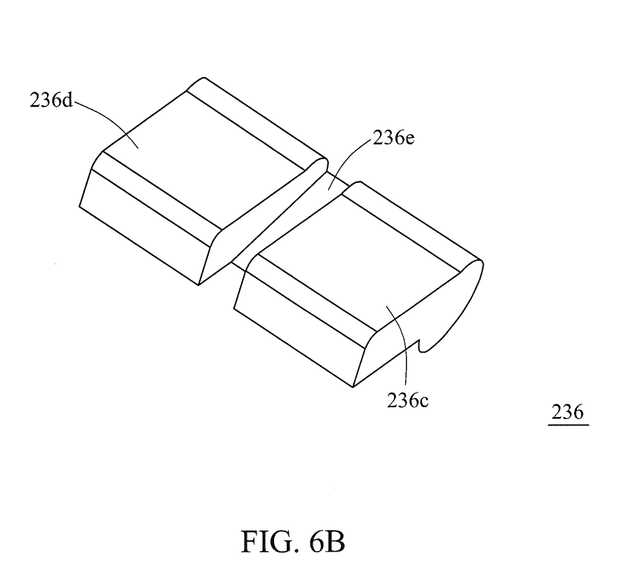

Please refer to FIGS. 5 and 6A, in which FIG. 5 shows an explosive drawing of a hub of the present embodiment, and FIG. 6A shows a schematic drawing of a ratchet wheel of the present embodiment. A hub 200, disposed on a bicycle 10, includes an arbor shaft 210, a shell 220, a ratchet wheel 230, an internally-toothed ring 240, a clutch member 250 and a second spring 260. The shell 220 is sleeved onto the arbor shaft 210. The ratchet wheel 230 is sleeved onto the arbor shaft 210 and includes a chain wheel 232, a plurality of concavities 234, a plurality of pawls 246 and a plurality of first springs 238. The chain wheel 232 is disposed on one side of the ratchet wheel 230, and the concavities 234 are disposed on the other side thereof Each concavity 234 has a first sub-concavity 234a, a second sub-concavity 234b and a bottom surface 234c, and each of the first sub-concavities 234a and the second sub-concavities 234b defines a cylinder space. In the present embodiment, the first sub-concavity 234a and the second sub-concavity 234b of the same concavity 234 are symmetric to each other, and the bottom surface 234c of each concavity 234 is connected between the first sub-concavity 234a and the second sub-concavity 234b of the same concavity 234.

Each of the pawls 236 has a first end 236a and a second end 236b. The first end 236a of each pawl 236 is disposed in one of the first sub-concavities 234a. Each of the first springs 238 has a first end 238a and a second end 238b. The first end 238a of each first spring 238 is disposed in one of the second sub-concavities 234b, and the second end 238b of each first spring 238 applies a resilient force on one of the pawls 236. Moreover, the internally-toothed ring 240 is sleeved on the arbor shaft 210 and surrounds the aforesaid pawls 236. The internally-toothed ring 240 has an inner periphery formed with a plurality of teeth 242. Each tooth 242 is adapted for the second end 236b of one of the pawls 236 to engage therewith. Please refer to FIG. 6B, which shows a schematic drawing of a pawl of the present invention. Each pawl 236, for example, includes a first claw plate 236c, a second claw plate 236d and a connecting surface 236e. The connecting surface 236e of each pawl 236 is connected between the first claw plate 236c and the second claw plate 236d of the same pawl 236. The second end 238b of each first spring 238 abuts against one of the connecting surfaces 236e.

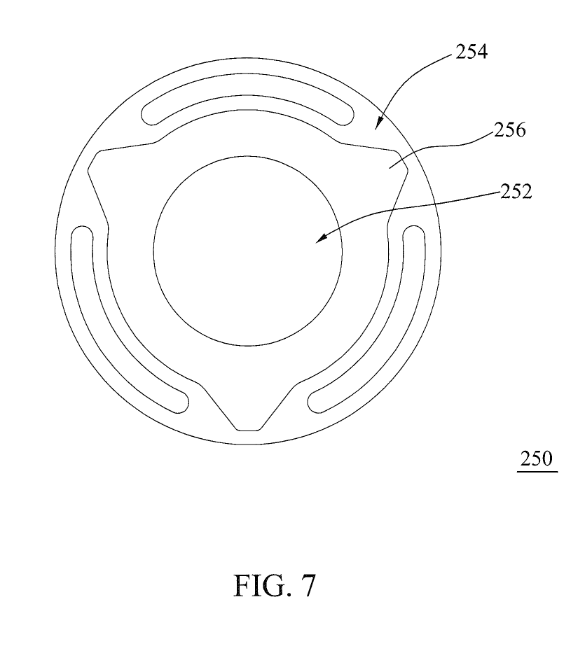

Please refer to FIGS. 5 and 7, in which FIG. 7 shows a schematic drawing of a clutch member of the present embodiment. The clutch member 250 has an axial hole 252, and the clutch member 250 is sleeved onto the arbor shaft 210 with the axial hole 252. The clutch member 250 has a cam 254. The cam 254 has a plurality of protrusions 256, in which the protrusions 256 are corresponded to the pawls 236 respectively. In addition, the hub 200 further includes a second spring 260. The second spring 260 is also sleeved onto the arbor shaft 210, and the second spring 260 has one of its ends applying a resilient force on the clutch member 250 and presses the clutch member 250 against the ratchet wheel 230. In the present embodiment, the hub 200 further includes a sleeve 270. The sleeve 270 is, for example, made of metal. The sleeve 270 is mounted in the axial hole 252 of the clutch member 250 and sleeved on the arbor shaft 210.

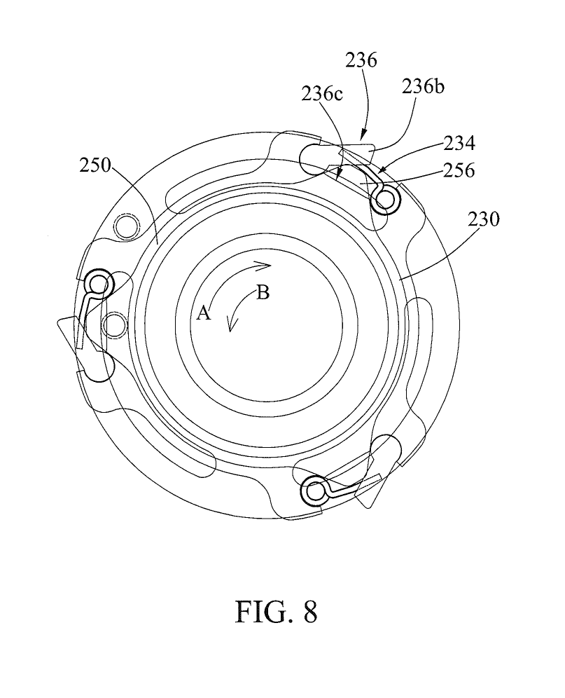

Please refer to FIG. 8, which shows a diagram illustrating a relative movement of a ratchet wheel and a clutch member of the present embodiment. When the ratchet wheel 230 rotates in a first direction A relative to the clutch member 250, the protrusions 256 of the cam 254 abut against the pawls 236 to make the second ends 236b of the pawls 236 protrusive from the concavities 234 respectively. When the ratchet wheel 236 rotates in a second direction B relative to the clutch member 250, the protrusions 256 of the cam 254 are separated from the pawls 236 such that the pawls 236 are retracted into the concavities 234 and appressed to the bottom surfaces 234c of the concavities 234 by the resilient force applied by the first springs 238, in which the first direction A is opposite to the second direction B.

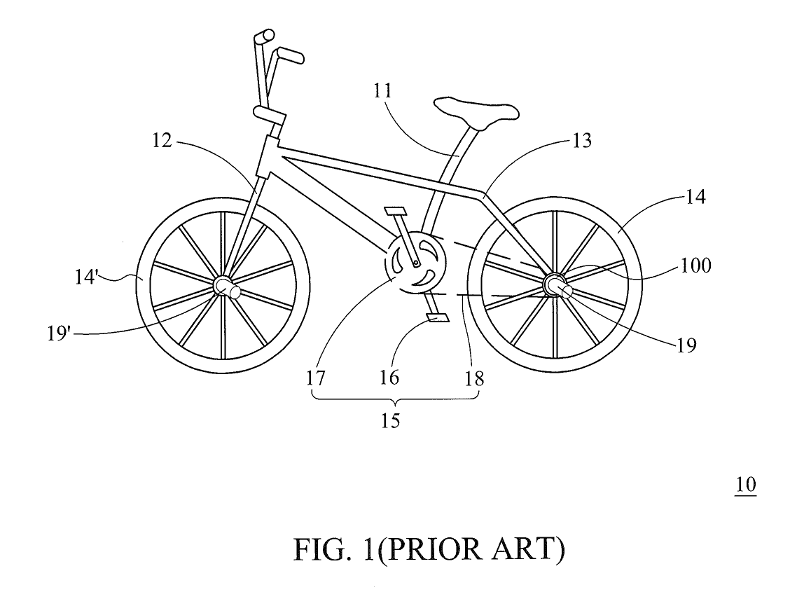

When the chain 18 (as shown in FIG. 1) of the bicycle 10 pulls the second chain wheel 232 to rotate in clockwise direction, i.e. the first direction A of the present embodiment, the ratchet wheel 230 will rotate in the first direction A relative to the clutch member 250. At the same time, the protrusions 256 of the cam 254 abut against the pawls 236 and make the second ends 236b of the pawls 236 protrusive from the concavities 234 to engage with the teeth 242 and drive the internally-toothed ring 240 to rotate. When the internally-toothed ring 240 rotates, the shell 220 is rotated as well and drives the bicycle 10 forward.

On the other hand, when the chain 18 pulls the second chain wheel 232 to rotate in counterclockwise direction, i.e. the second direction B of the present embodiment, the ratchet wheel 236 will rotate in the second direction B relative to the clutch member 250. Therefore, the protrusions 256 of the cam 254 will be separated from the pawls 236 such that the pawls 236 are retracted into the concavities 234 and appressed to the bottom surface 234c of the concavities 234 by the resilient force applied by the first springs 238. Because the pawls 236 are retracted into the concavities 234, the pawls 236 cannot contact the teeth 242 of the internally-toothed ring 240 and thus do not make “kada-kada” rattle noise.

Please further refer to FIG. 1 simultaneously. When the rear wheel 14 idly rotates counterclockwise and drives the internally-toothed ring 240 to rotate in the same direction, the teeth 242 of the internally-toothed ring 240 will not engage with the pawls 236 since the pawls 236 have already been retracted into the concavities 234. As a result, the ratchet wheel 230 and the chain 18 are not driven, nor are the pedals 16. Thus there is no need to worry that the rotation of the pedals 16 could interfere or hurt the cyclist. In addition, the hub of the present invention, compared with the conventional art as disclosed in '167, has simplified structure, which can make the hub of the present invention easy to manufacture and more competitive in price.

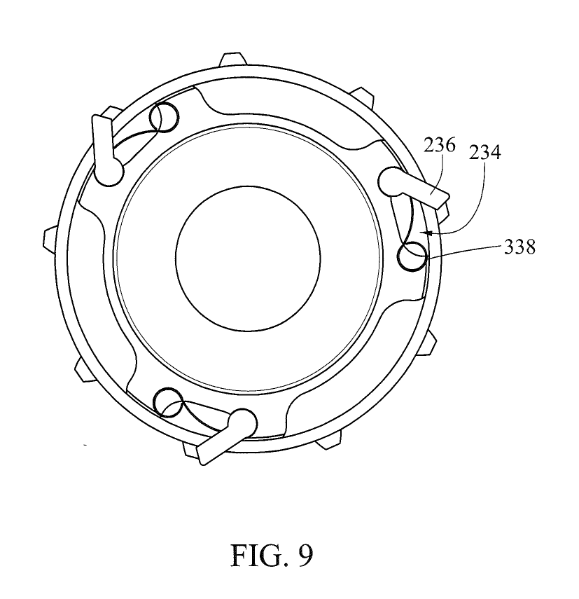

Although the hub 200 is a free coaster hub in the aforementioned embodiment, the hub 200 can be transformed into a normal cassette hub from a free coaster hub by substitution of the first springs 238 into the first springs 338 as shown in FIG. 9. The difference between the first springs 338 and the first springs 238 is that the first springs 238, as shown in FIG. 6, retract the pawls 236 into the concavities 234 with its resilient force, the first springs 338, however, urge the ends of the pawls 236 protrusive from the concavities 234 with its resilient force. Therefore, the manufacturing flexibility of the present invention can be increased since the type transformation of the hub can be simply done by the substitution of the first springs.

1. A hub for disposed on a bicycle, characterized in that the hub comprising:
an arbor shaft;
a ratchet wheel, sleeved onto the arbor shaft, the ratchet wheel comprising:
at least one chain wheel, disposed on one side of the ratchet wheel;
a plurality of concavities, disposed on the other side of the ratchet wheel, each concavity having a first sub-concavity, a second sub-concavity and a bottom surface, each of the first sub-concavities and the second sub-concavities defining a cylinder space, the bottom surface of each concavity being connected between the first sub-concavity and the second sub-concavity of the same concavity;
a plurality of pawls, each pawl having a first end and a second end, the first end of each pawl being disposed in one of the first sub-concavities; and
a plurality of first springs, each first spring having a first end and a second end, the first end of each first spring being disposed in one of the second sub-concavities, the second end of each first spring applying a resilient force on one of the pawls;
an internally-toothed ring, surrounding the pawls, the internally-toothed ring having an inner periphery formed with a plurality of teeth, each tooth being adapted for the second end of one of the pawls to engage therewith;
a shell, sleeved onto the arbor shaft;
a clutch member, having an axial hole, the clutch member being sleeved onto the arbor shaft with the axial hole, the clutch member having a cam, the cam having a plurality of protrusions, each protrusion being corresponded to one of the pawls; and
a second spring, sleeved onto the arbor shaft, the second spring having one of its ends applying a resilient force on the clutch member and pressing the clutch member against the ratchet wheel;
wherein, when the ratchet wheel rotates in a first direction relative to the clutch member, each protrusion of the cam abuts against the respective pawl to make the second end of the respective pawl protrusive from the respective concavity, when the ratchet wheel rotates in a second direction relative to the clutch member, each protrusion of the cam is separated from the respective pawl such that the respective pawl is retracted into the respective concavity by the resilient force applied by the respective first spring; wherein the first direction is opposite to the second direction.

2. The hub of claim 1, wherein the first sub-concavity and the second sub-concavity of each concavity are symmetric to each other.

3. The hub of claim 1, wherein each pawl comprises a first claw plate, a second claw plate and a connecting surface, the connecting surface of each pawl is connected between the first claw plate and the second claw plate of the same pawl, the second end of each first spring abuts against one of the connecting surfaces, when the ratchet wheel rotates in the second direction relative to the clutch member, each protrusion of the cam is separated from the respective pawl such that the respective pawl is retracted into the respective concavity and appressed to the bottom surface of the respective concavity by the resilient force applied by the respective first spring.

4. The hub of claim 1, further comprising a sleeve, wherein the sleeve is mounted in the axial hole of the clutch member and sleeved onto the arbor shaft.

5. The hub of claim 4, wherein the sleeve is made of metal.

6. A ratchet wheel for disposed in a hub of a bicycle, the hub comprising a clutch member and a second spring, the clutch member being sleeved onto an arbor shaft, and the clutch member having a cam, the cam having a plurality of protrusions, the second spring is sleeved onto the arbor shaft and applying a resilient force on the clutch member, the ratchet wheel being characterized in that the ratchet wheel comprising:
at least a chain wheel, disposed on one side of the ratchet wheel;
a plurality of concavities, disposed on the other side of the ratchet wheel, each concavity having a first sub-concavity, a second sub-concavity and a bottom surface, each first sub-concavities and second sub-concavities defining a cylinder space, the bottom surface of each concavity being connected between the first sub-concavity and the second sub-concavity of the same concavity;
a plurality of pawls, each pawl having a first end and a second end, the first end of each pawl is disposed in one of the first sub-concavities; and
a plurality of first springs, each first spring having a first end and a second end, the first end of each first spring being disposed in one of the second sub-concavities, the second end of each first spring applying a resilient force on one of the pawls;
wherein, each protrusion of the cam is corresponded to one of the pawls, when the ratchet wheel rotates in a first direction relative to the clutch member, each protrusion of the cam abuts against the respective pawl to make the second end of the respective pawl protrusive from the respective concavity, when the ratchet wheel rotates in a second direction relative to the clutch member, each protrusion of the cam is separated from the respective pawl such that the respective pawl is retracted into the respective concavity by the resilient force applied by the respective first spring; wherein the first direction is opposite to the second direction.

7. The ratchet wheel of claim 6, wherein the first sub-concavity and the second sub-concavity of each concavity are symmetric to each other.

8. The ratchet wheel of claim 6, wherein each pawl comprises a first claw plate, a second claw plate and a connecting surface, the connecting surface of each pawl is connected between the first claw plate and the second claw plate of the same pawl, the second end of each first spring abuts against one of the connecting surfaces, when the ratchet wheel rotates in the second direction relative to the clutch member, each protrusion of the cam is separated from the respective pawl such that the respective pawl is retracted into the respective concavity and appressed to the bottom surface of the respective concavity by the resilient force applied by the respective first spring.
